(19) United States
(12) Patent Application Publication
(10) Pub. No.: US 2024/0429742 A1
(43) Pub. Date: Dec. 26, 2024

(54) METHODS FOR HANDLING ENERGY CONDITIONS OF AN ENERGY HARVESTING WIRELESS DEVICE, A RELATED NETWORK NODE AND A RELATED WIRELESS DEVICE

(71) Applicant: Sony Group Corporation, Tokyo (JP)

(72) Inventors: Anders BERGGREN, Lund (SE); Nafiseh Seyed MAZLOUM, Lund (SE); Torgny PALENIUS, Barsebäck (SE); Basuki PRIYANTO, Lund (SE)

(21) Appl. No.: 18/692,825

(22) PCT Filed: Sep. 16, 2022
(86) PCT No.: PCT/EP2022/075841

§ 371 Date: Mar. 17, 2024

(30) Foreign Application Priority Data
Sep. 30, 2021 (SE) 2151201-7

(51) Int. Cl. H02J 50/00; H02J 50/20; H02J 50/80; H04W 76/28

(52) U.S. Cl. CPC H02J 50/001; H02J 50/80; H02J 50/20; H04W 76/28

(57) ABSTRACT

A method is disclosed, performed in a network node, for handling energy conditions of an energy harvesting wireless device, WD. The method comprises receiving, from the WD, a message indicative of a present energy storage level and a present energy harvesting efficiency of the WD. The method comprises communicating, with the WD, based on the received message.

The present disclosure pertains to the field of wireless communications. The present disclosure relates to methods for handling energy conditions of an energy harvesting wireless device, a related network node and a related wireless device.

### BACKGROUND

Future services will likely require cellular connectivity everywhere, anytime and in everything. This means that the number of devices that have to be wirelessly connected, which are also referred to as internet of Things (IoT) devices, will likely increase. A vast majority of these devices are battery powered and their batteries need to be recharged or replaced.

Changing or recharging batteries manually is not feasible, e.g., a trillion-loT device in the world with 10-year battery life-time means that in total approximately 274 billion batteries need changing every day. In an loT context, 10-years battery life means a 10-years battery operation without charging which cannot even be fulfilled in many applications.

Recycling batteries is another factor that needs to be taken into account. For instance, in 2018, 191000 tones of portable batteries were sold in the EU but only near half the amount, i.e., 88000 tones of used portable batteries were collected as waste to be recycled.

This means that new approaches need to be used to sustain the world's battery requirement since these materials are very limited. Energy harvesting is a potential candidate that can help avoid an exploding request for batteries in the world and keep the limited natural materials un-harvested.

For certain applications of loT devices, for example devices that are placed in difficult to reach and/or remote locations, it may be difficult to charge the device frequently and/or manually. This kind of loT-device may typically be reporting sensor outputs infrequently. It may be equipped with a limited battery capacity. Hence, it may be charged in full capacity using energy harvesting.

Harvesting resources, however, might not be available all the time, especially if they are harvested from ambient or natural resources. An energy harvesting capability of the device also depends on whether a device is stationary in an indoor or outdoor environment or is a mobile device, as the intensity of energy harvesting can vary based on its location and its activity. Consequently, the loT-device might not be able to communicate with the network or other devices during a certain period when the instantaneous harvesting energy is not available, not enough, and/or the stored energy level drops below a certain level. This condition may typically lead to excessive unnecessary signaling which may increase the overhead and usage of unnecessary energy resources when the device has harvested enough energy and restarts communication. SUMMARY

Accordingly, there is a need for devices and methods for handling energy conditions of an energy harvesting wireless device, which may mitigate, alleviate, or address the existing shortcomings and may provide a solution that reduces energy consumption and latency for communications with an energy harvesting device.

A method is disclosed, performed in a network node, for handling energy conditions of an energy harvesting wireless device, WD. The method comprises receiving, from the WD, a message indicative of a present energy storage level and a present energy harvesting efficiency of the WD. The method comprises communicating, with the WD, based on the received message.

Further, a network node is provided, the device comprising memory circuitry, processor circuitry, and a wireless interface, wherein the network node is configured to perform any of the methods disclosed herein for the network node.

It is an advantage of the present disclosure that the network node may be informed about a present energy level and energy harvesting efficiency of the energy harvesting WD. The network node may use this information to communicate with the WD in a manner that allows the WD to harvest the energy required for communication with the network node for its present energy level and energy harvesting efficiency. It can thereby be ensured that the energy harvesting WD and the network node can adapt the communication based on the WD energy level and energy harvesting efficiency and thereby communicate without the WD becoming unavailable or the communication becoming mis-aligned due to an interruption period caused by the energy level of the WD being insufficient for communication. In other words, the communication between the WD and the network node is performed intelligently based on the present energy conditions, such as the present energy level and present energy harvesting efficiency, of the WD. The network node may for example adjust a configuration applied when communicating with the WD to allow the WD more time between communication periods to harvest energy. By adjusting the communication, such as the configuration applied when communicating with the WD, the energy consumption of the WD may be reduced and/or the time available to the WD for energy harvesting can be increased, thereby reducing the risk of the energy level of the WD being insufficient for communication.

Further, a method is disclosed, performed in an energy harvesting wireless device, WD, for handling energy conditions of the WD. The method comprises transmitting, to the network node, a message indicative of a present energy storage level and a present energy harvesting efficiency of the WD. The method comprises communicating, with the network node, based on the transmitted message indicative of the present energy storage level and the present energy harvesting efficiency of the WD.

Further, a wireless device is provided, the device comprising memory circuitry, processor circuitry, and a wireless interface, wherein the wireless device is configured to perform any of the methods disclosed herein for the wireless device.

It is an advantage of the present disclosure that the WD may inform the network node about a present energy level and energy harvesting efficiency of the WD. The network node may use this information to communicate with the WD in a manner that allows the

WD to harvest the energy required for communication with the network node for its present energy level and energy harvesting efficiency. It can thereby be ensured that the energy harvesting WD and the network can adapt the communication based on the energy level and energy harvesting efficiency of the WD. Thereby the WD and the network node can communicate without the WD becoming unavailable or the communication becoming mis-aligned due to an interruption period caused by the energy level of the WD being insufficient for communication. In other words, the communication between the WD and the network node can be performed intelligently based on the present energy conditions information, such as the present energy level and present energy harvesting efficiency, of the WD. The WD may for example receive an adjusted configuration to be applied when communicating with the WD. The adjusted configuration may allow the WD more time between communication periods to harvest energy. By adjusting the communication, such as the configuration applied when communicating with the network node, the energy consumption of the WD may be reduced and/or the time available to the WD for energy harvesting can be increased, thereby reducing the risk of the energy level of the WD becoming insufficient for communication.

### BRIEF DESCRIPTION OF THE DRAWINGS

The above and other features and advantages of the present disclosure will become readily apparent to those skilled in the art by the following detailed description of examples thereof with reference to the attached drawings, in which:

FIG. 1 is a diagram illustrating an example wireless communication system comprising an example network node and an example WD according to this disclosure,

FIG. 2 is a timing diagram for an uplink transmission for a legacy energy harvesting WD and a known network node in connected mode,

FIG. 3 is a timing diagram for an uplink transmission for a WD and a network node in connected mode according to this disclosure,

FIG. 4 is a signaling diagram illustrating an exemplary message exchange for handling energy conditions of an energy harvesting WD according to this disclosure,

FIG. 5 is a flow-chart illustrating an example method, performed in a network node, for handling energy conditions of an energy harvesting WD according to this disclosure,

FIG. 6 is a flow-chart illustrating an example method, performed in an energy harvesting WD, for handling energy conditions of the energy harvesting WD according to this disclosure,

FIG. 7 is a block diagram illustrating an example network node according to this disclosure, and

FIG. 8 is a block diagram illustrating an example WD according to this disclosure.

### DETAILED DESCRIPTION

Various examples and details are described hereinafter, with reference to the figures when relevant. It should be noted that the figures may or may not be drawn to scale and that elements of similar structures or functions are represented by like reference numerals throughout the figures. It should also be noted that the figures are only intended to facilitate the description of the examples. They are not intended as an exhaustive description of the disclosure or as a limitation on the scope of the disclosure. In addition, an illustrated example needs not have all the aspects or advantages shown. An aspect or an advantage described in conjunction with a particular example is not necessarily limited to that example and can be practiced in any other examples even if not so illustrated, or if not so explicitly described.

A connected mode may be referred to an operation mode wherein a data transmission can be communicated e.g., between the WD and a network node or between the WD and another WD. A connected mode may be referred to an operation state wherein a radio transmitter and/or a radio receiver is activated for such communication. A connected mode may be referred to an operation state wherein the WD is synchronized time-wise and/or frequency-wise e.g., by a determined timing advance parameter for the communication. Furthermore, it may be referred to as an operation state wherein transfer of unicast data to/from the WD can be performed. In certain communication systems, a connected mode may be referred to a radio resource control (RRC) state. In various examples, an active state may be a RRC connected state and/or an RRC active state. However, a connected mode may be an active period within another RRC state.

The dormant mode is a mode where the WD has no active connection with the network node. A dormant mode may be seen as an inactive mode of the WD. A dormant mode may be seen as a mode where the WD is unsynchronized with a timing of a network. In one or many examples the WD may in a dormant mode not have a valid timing advance information with respect to the network. A dormant mode may be seen as a mode where the WD may not be able to receive dedicated signaling. A dormant mode may be seen as a mode where closed loop power control is inactivated or suspended. Dormant mode May comprise RRC idle mode, RRC suspend, RRC inactive mode and/or a WD power save mode in which the WD is not monitoring paging and following Discontinuous Reception (DRX) cycles. For example, the WD may be in dormant mode when the connection with the network node has been released and/or suspended.

The figures are schematic and simplified for clarity, and they merely show details which aid understanding the disclosure, while other details have been left out. Throughout, the same reference numerals are used for identical or corresponding parts.

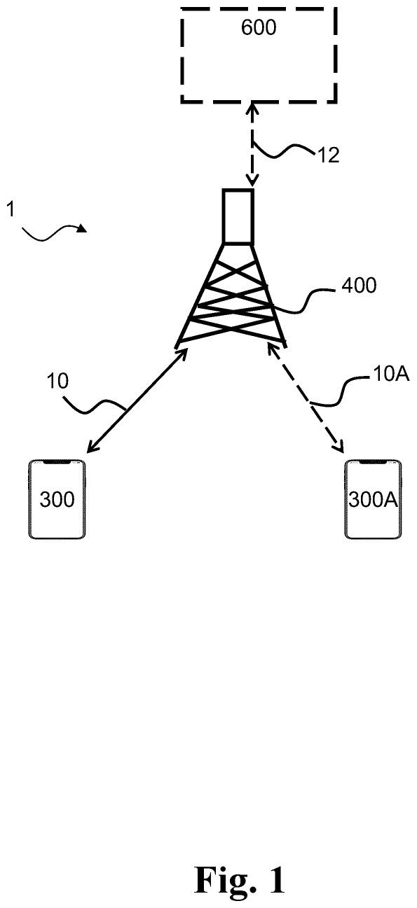

FIG. 1 is a diagram illustrating an example wireless communication system 1 comprising an example core network (CN) node 600, a radio network node 400 and an example wireless device (WD) 300 according to this disclosure.

As discussed in detail herein, the present disclosure relates to a wireless communication system 1 comprising a cellular system, for example, a 3GPP wireless communication system. The wireless communication system 1 comprises a WD 300 and/or a network node 400. The WD 300 may be an energy harvesting WD configured to use energy harvesting sources to harvest the energy required by the WD 300 for communicating with the network node 400 or a second WD 300A.

A network node disclosed herein refers to a radio access network (RAN) node operating in the radio access network or a CN node operating in the core network. The RAN node may be one or more of a base station, an evolved Node B, eNB, gNB in NR. In one or more examples, the RAN node is a functional unit which may be distributed in several physical units.

A core network, CN, node disclosed herein refers to a network node operating in the core network, such as in the Evolved Packet Core Network, EPC, and/or a 5G Core Network, 5GC. Examples of CN nodes in EPC include a Mobility Management Entity, MME. Examples of CN nodes in 5GC include Access and Mobility Management Function (AMF) and Service Management Function (SMF). In one or more examples, the CN node is a functional unit which may be distributed in several physical units.

The CN node 600 may be configured to communicate with the RAN node 400 via a link, such as a wired link, 12.

The wireless communication system 1 described herein may comprise one or more WDs 300, 300A, and/or one or more network nodes 400, such as one or more of: a base station, an eNB, a gNB and/or an access point, and one or more CN nodes 600.

A WD may refer to a mobile device, a user equipment (UE) and/or other devices having wireless capability, such as e.g., sensors wirelessly transmitting the measured data.

The WD 300, 300A may be configured to communicate with the network node 400 via a wireless link (or radio access link) 10, 10A.

Energy harvesting resources for harvesting energy by the WD may not be available all the time, especially if the energy harvesting resources are ambient or natural resources. Additionally, the amount of energy that can be stored in a WD may be limited and the WD may thus run out of the back-up stored energy if the WD is not able to harvest energy. Consequently, the WD may not be able to communicate with the network or other devices during a certain period when the instantaneous harvesting energy is not sufficient and/or the stored energy level drops below a certain level.

To address this issue, the current disclosure provides a method for communicating with the energy harvesting WD, such as by selecting and adapting a parameter setting (such as one or more parameter settings) for uplink and downlink transmission and their corresponding scheduling, based on availability of energy in the energy harvesting WD.

Mobile-originated traffic, such as uplink (UL) traffic, or mobile-terminated communication, such as downlink (DL) traffic, are typically performed following a certain configuration for downlink channel monitoring and/or downlink reception, such as DRX configuration, or a certain scheduling rule for uplink and/or downlink transmission. These configurations may be adjusted to support WDs operating on energy harvesting techniques, by allowing a certain configuration for a certain harvesting capability. For instance, a certain time-gap can be configured in between Physical Uplink Shared Channel (PUSCH) occasions when scheduling an uplink transmission, when the WD is in connected mode. During this time-gap the WD can harvest energy. The time-gap may be selected based on a harvesting capability reported by the WD. The time-gap may be selected to guarantee that the WD, after the time-gap, has sufficient energy to proceed with its communication, such as with uplink transmission or downlink reception. For instance, a certain time-gap can be configured in between Physical downlink shared channel (PDSCH) when scheduling a downlink transmission, when WD is in connected mode. For instance, downlink control channel (PDCCH) monitoring/transmission are adjusted allowing a time-gap between PDCCH monitoring/transmission occasion.

The level of harvested energy strongly depends on the performance (such as the availability) of the energy harvesting resources. For example, a performance level of a photovoltaic cell harvesting from sun strongly depends on the technology the cell is built on, the sun intensity, orientation of the cells toward the sun, whether the cell is placed in an indoor environment with windows or an indoor environment without any window and so on. Therefore, adjusting the configuration based on only the WD's reported harvesting capability and/or the energy level may not be sufficient since the communication between the WD and the network node can become mis-aligned as the WD might not have sufficient energy to listen to the channel for potential downlink data or to proceed with its uplink transmission. This may lead to the network node and the WD not being able to communicate with each other efficiently.

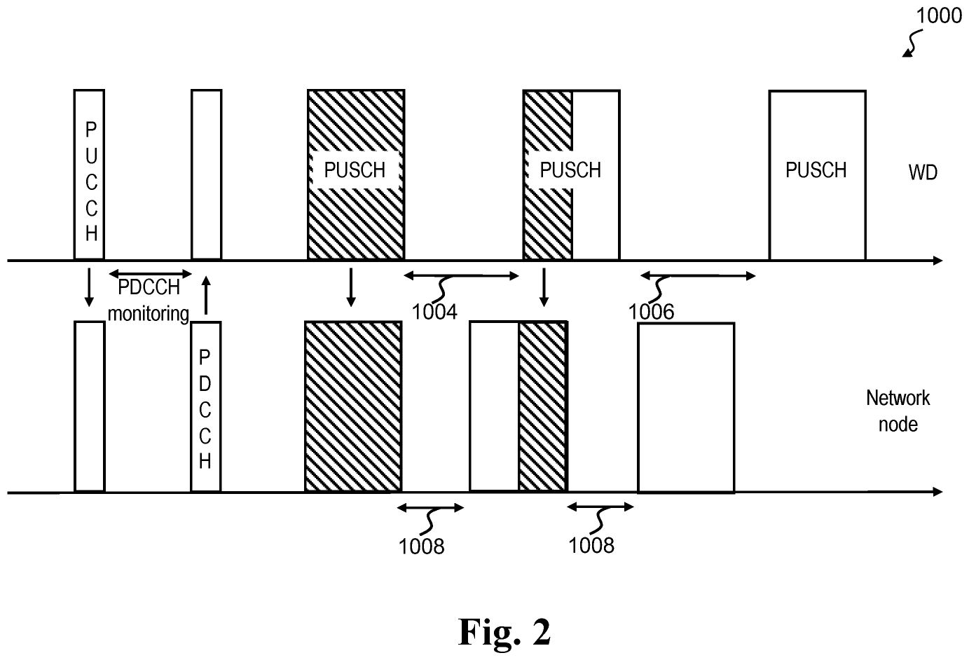

FIG. 2 shows a timing diagram 1000 for an uplink transmission for a legacy energy harvesting WD and a legacy network node, wherein the WD is in connected mode. The WD may request an UL transmission from the network in a PUCCH occasion. The WD may then monitor for a PDCCH occasion comprising an UL grant. The UL grant may comprise an UL scheduling, such as a scheduling of PUSCH occasions for UL transmission, such as UL data transmission, so that the WD can perform regular PUSCH, semi-persistent PUSCH, or repetitive PUSCH. The UL scheduling may comprise a time-gap can be configured based on a capability report of the WD. In other words, both the transmission from the WD (shown in the upper timing diagram of FIG. 2) and the reception by the network node (shown in the lower timing diagram of FIG. 2) are configured with the same time-gaps between PUSCH occasions. However, due to low energy levels of the WD, the WD may have to harvest energy for a longer time 1004 than the configured time-gap 1008 before it can resume its transmission over the PUSCH. Thereby the transmission from the WD to the network node may be delayed, in which case the WD may only be able to utilize half of the scheduled PUSCH resource for UL transmission, as can be seen for the second PUSCH occasion in FIG. 2. In one or more examples, such as for example when a following energy harvesting period 1006 of the WD is also delayed, the transmission from the WD and the configured PUSCH occasion of the network node may be completely misaligned, such that the WD cannot utilize any of the resources in the PUSCH occasion, as can be seen for the third PUSCH occasion in FIG. 2.

The current disclosure addresses this issue and proposes a method for adjusting a communication between the network node and the WD, such as for adjusting a transmission parameter setting and/or configuration when the WD operates using one or more harvesting resources to allow an efficient communication between the network node and the energy harvesting WD.

According to one or more examples of the current disclosure, an adjustment of the transmission configuration and the parameter settings of an uplink transmission and uplink scheduling based on WD's energy harvesting efficiency, such as how quickly the WD can harvest energy, its storage device, such as whether it is a re-chargeable Li-ion battery, thin-film battery, super-capacitor, or conventional capacitor, and their respective storage capacities, is provided.

According to one or more examples of the current disclosure, an adjustment of the WD's channel monitoring and discontinues reception configuration in IDLE mode, INACTIVE mode and/or CONNECTED mode based on the WD's energy harvesting efficiency and its storage device is provided.

According to the current disclosure, a WD with energy harvesting capability, herein also referred to as an energy harvesting WD, may report an energy harvesting efficiency in addition to the WD's currently used harvesting resource and the current energy level of the WD. The energy harvesting efficiency may be indicative of a current energy harvesting performance of the WD, such as how quickly the WD can recharge its energy storage. In one or more example methods, the report may be transmitted periodically. In one or more example methods, the report may be transmitted semi-statically by the WD, such as upon the request from the network node. In one or more example methods, the report can also be transmitted if the WD's harvesting capability or harvesting performance status changes.

Based on the reported energy harvesting efficiency, the network node may adjust a configuration for communicating with the WD.

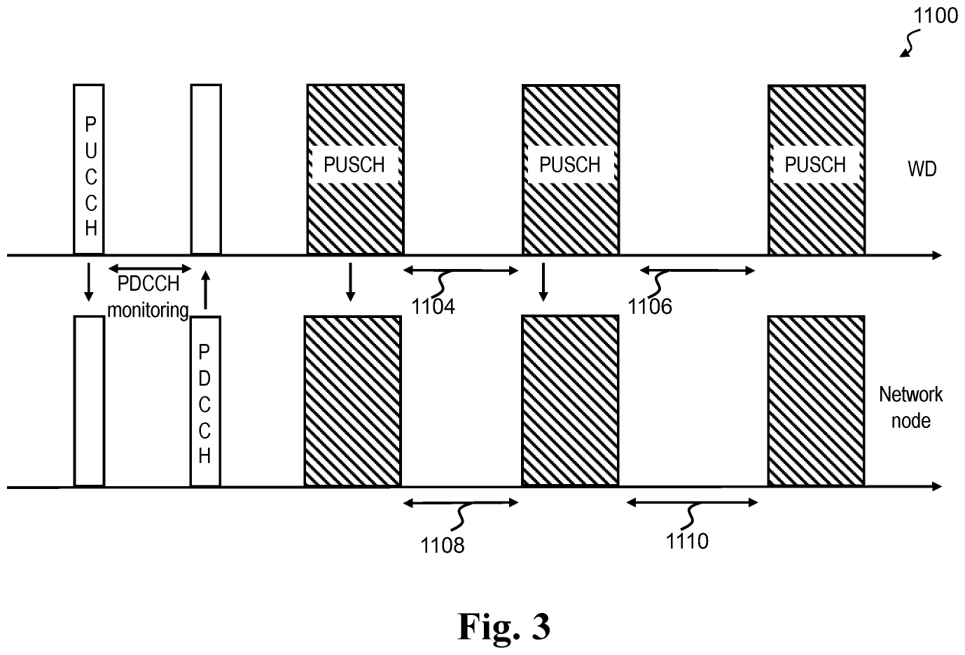

In one or more example methods, adjusting the configuration for communicating with the WD may comprise adjusting a configuration for UL transmission operation as shown in FIG. 3.

FIG. 3 shows an example timing diagram 1100 for an uplink transmission for a WD and a network node in connected mode according to this disclosure. The WD may request an UL transmission from the network in the PUCCH occasion. The WD may then monitor for a PDCCH occasion comprising an UL grant. The UL grant may comprise an UL scheduling, such as a scheduling of PUSCH occasions for UL transmission, such as UL data transmission, so that the WD can perform regular PUSCH, semi-persistent PUSCH, or repetitive PUSCH. In the example shown in FIG. 3 one PDCCH comprises an UL grant for a plurality of PUSCH occasions. However, in one or more example methods, the network node may send UL grants for each PUSCH in a dedicated PDCCH. The network node may receive a message from the WD via PUCCH (as shown in FIG. 3) or via PUSCH indicative of a harvesting efficiency and/or a present energy level of the WD. The message may in one or more example methods, be indicative of a change in the harvesting efficiency of the WD. Based on the received message the network node may adjust a time-gap in the UL scheduling, such as time-gaps 1104, 1106, 1108 and 1110 between PUSCH occasions, as shown in FIG. 3. However, the adjusted time-gaps may also be between a PUSCH occasion and a PDCCH or a PUCCH occasion. The time-gaps 1104, 1106, 1108 and 1110 may be used by the WD to perform energy harvesting to store energy in its energy storage device. The time-gaps 1104, 1106, 1108 and 1110 may be adjusted based on a report and/or assistance information provided by the WD. The WD may provide the report based on a triggering rule. The network node may provide the adjusted configuration, such as the updated UL time-gap pattern based on the report and/or assistance information received from the WD. For example, a WD having a low energy harvesting efficiency, such as a slow charging, may be configured to have short uplink durations and longer time-gaps, such as for harvesting energy. The adjusted configuration may in one or more examples be provided to the WD via the PDCCH (as shown in FIG. 3) or via the PDSCH. The adjusted configuration may in one or more examples be provided via a wake-up signal. The adjusted configuration may in one or more examples be provided to the WD via a code-bits or code-map. The WD and the network node may apply the adjusted configuration, such as the adjusted time-gaps 1104, 1106, 1108 and 1110, thereby allowing the WD to harvest enough energy during the time-gaps to allow the WD to communicate with the network node during the configured PUSCH occasions. By applying the adjusted configuration, the PUSCH occasions for the WD and the network node will be aligned while allowing the WD sufficient time between the PUSCH occasions to perform energy harvesting.

In one or more example methods, the adjusting may comprise adjusting a configuration for downlink channel monitoring for PDCCH reception and downlink transmission operation. Adjusting the configuration for UL transmission operation may in one or more examples comprise adjusting a DRX sleep/on period or a channel monitoring skipping based on a triggering rule. The time for channel monitoring may be adjusted such that the WD can perform energy harvesting to store energy in its storage device.

The triggering rule may in one or more example methods be indicated in a pre-defined table, such as a in look-up table, associating the level of energy harvesting efficiency and a corresponding energy harvesting resource to a threshold.

The adjusting of the configuration for communicating with the WD may in one or more example methods, be performed upon one or more adjustment criterions being fulfilled. The one or more adjustment criterions may comprise one or more of:
The energy storage level of the WD being equal to or below an energy storage level threshold,
the energy storage level of the WD being equal to or above an energy storage level threshold,
the energy harvesting efficiency being equal to or below a first energy harvesting efficiency threshold for one or more energy harvesting resources of the WD,
the energy harvesting efficiency being equal to or above a second energy harvesting efficiency threshold for one or more energy harvesting resources of the WD, and
a combination of both energy storage level AND energy harvesting efficiency being equal to a certain threshold or level for one or more energy harvesting resources of the WD.

In one or more example methods, the WD may indicate a preferred adjustment of its configuration for communicating with the network node to the network node. In other words, the WD may transmit its preferred configuration values to the network node. In one or more example methods the network node may perform the adjusting of the configuration upon receiving the preferred adjustment from the WD. The adjusting of the configuration may be performed based on the indicated preferred adjustment.

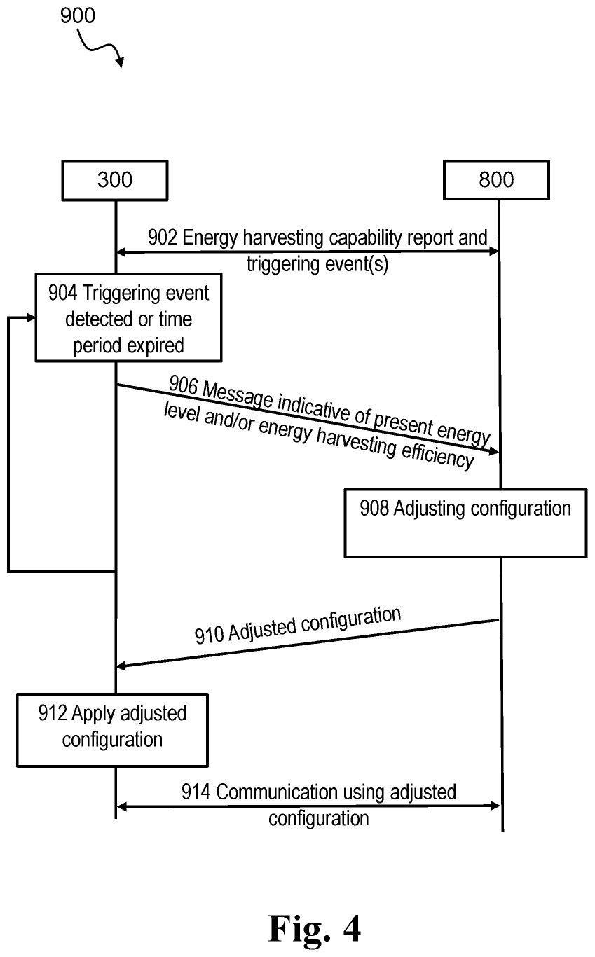

FIG. 4 shows a message exchange between a WD 300 and a network node 800 according to one or more example methods disclosed herein. The network node 800 may be a RAN node 400 or a CN node 600 communicating with the WD 300 via a RAN node 400. The

WD 300 may communicate over an air interface, either with the RAN node 400, or with the CN node 600 via the RAN node 400. Traffic in terms of CN signaling or user data traffic from or to the CN node 600 may be carried transparently through the RAN node 400.

The WD 300 may be registered to the network, such as with the network node 800, and may have a UE context with the network. The UE context may be seen as a set of information associated with the WD that may be advantageous and/or necessary for communication with the core network, such as to maintain one or more services, such as to support one or more radio bearers, such as for Quality-of-service classes. For example, the UE context may comprise information indicative of a capability of the WD, such as an energy harvesting capability of the WD, and/or information indicative of the UE state and/or security information, and/or subscription identifiers and/or mobility information, such as defined in 3GPP TS 36.410 v. 16.0.0. and TS 23.502 v. 16.9.0. The UE context may comprise an EPS Radio Access Bearer (E-RAB) context, security context, roaming and access restrictions, UE S1 signaling connection ID(s). The UE context may be a set of information agreed upon between the WD and the network node during a registration procedure of the WD with the network.

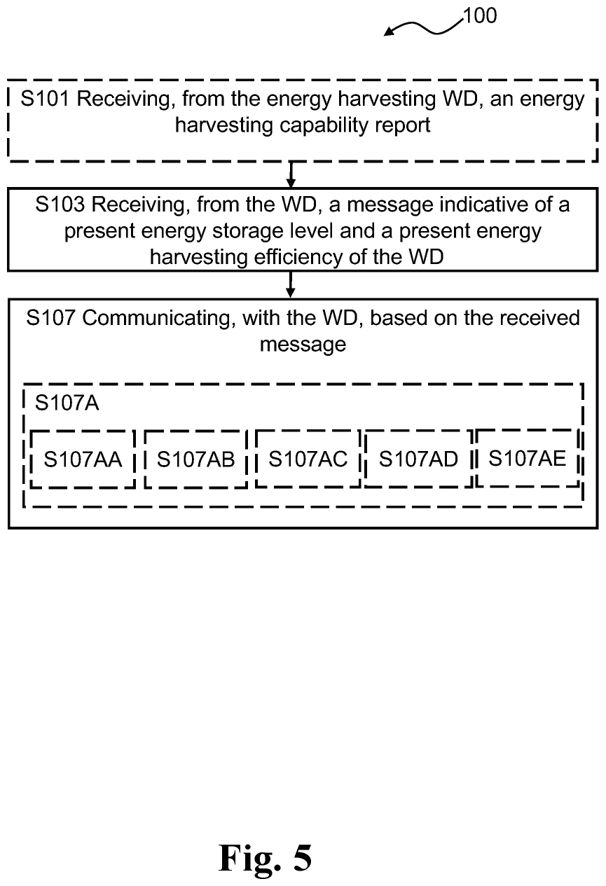

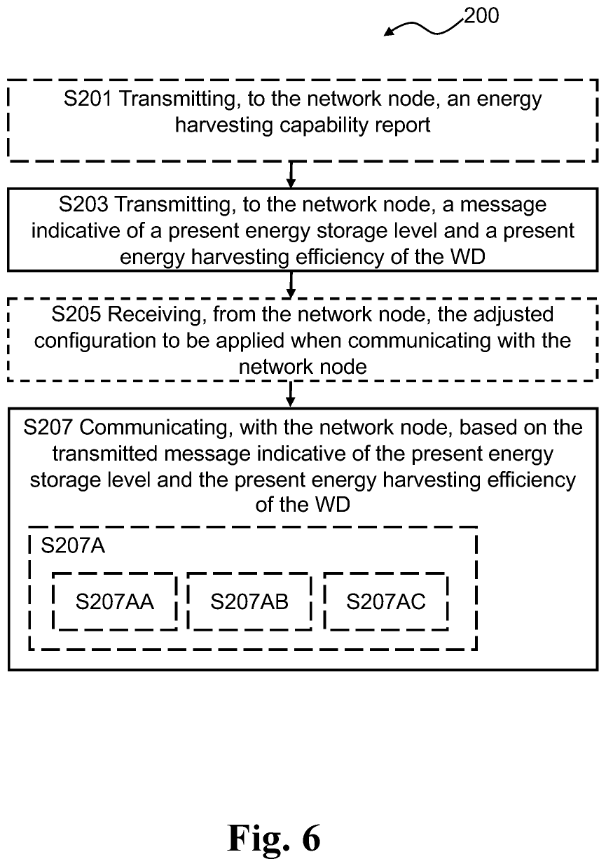

During or after the registration process-the WD 300 may transmit a set of parameters 902, such as an energy harvesting capability report indicative of one or more of a type of a harvesting resource, an energy harvesting capacity of a harvesting resource and an energy storage capacity available to the WD 300 to the network node 800. The parameters may be transmitted by performing an RRC re-configuration procedure with the network node 800 During the registration process the WD 300 and the network node 800 may negotiate 902 a set of thresholds triggering an adjustment of a configuration for communication between the WD 300 and the network node 800. The parameters and/or thresholds may indicate a triggering event triggering an adjustment of the transmission configuration for different scenarios and for different energy harvesting techniques and/or energy harvesting resources available to the WD. The set of thresholds may comprise on or more of an energy storage level threshold, and one or more energy harvesting efficiency thresholds. The set of parameters and thresholds may be determined based on the energy harvesting capability report transmitted by the WD. This corresponds to S101 performed by the network node in FIGS. 5 and S201 performed by the WD in FIG. 6.

The WD 300 may monitor its energy harvesting efficiency for its energy harvesting resources and/or its energy storage level. Upon detecting of a triggering event, such as the energy level and/or energy harvesting efficiency being equal to or below a threshold, or after a time period has expired 904, the WD transmits a message 906 indicative of a present energy storage level and a present energy harvesting efficiency of the WD to the network node. This message 906 corresponds to the message transmitted by the WD in step S203 of FIG. 6 and received by the network node in S103 of FIG. 5.

Based on the message 906 indicative of a present energy storage level and a present energy harvesting efficiency of the WD the network node 800 adjusts 908 a configuration for communicating with the WD 300. The configuration may be adjusted to allow the WD sufficient time to harvest energy required for communication based on the present energy storage level and a present energy harvesting efficiency of the WD. Adjusting 908 corresponds to adjusting S107 performed by the network node in FIG. 5.

The network node 800 transmits the adjusted configuration 910 to the WD 300. This corresponds to S107AB performed by the network node in FIGS. 5 and S205 performed by the WD in FIG. 6.

The WD 300 may apply 912 the adjusted configuration to communications with the network node 800.

The WD 300 and the network node 800 may resume communication using the adjusted configuration. This corresponds to S107 performed by the network node in FIGS. 5 and S207 performed by the WD in FIG. 6.

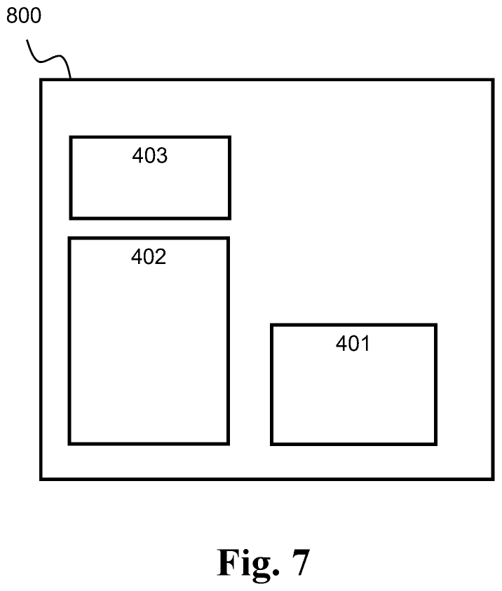

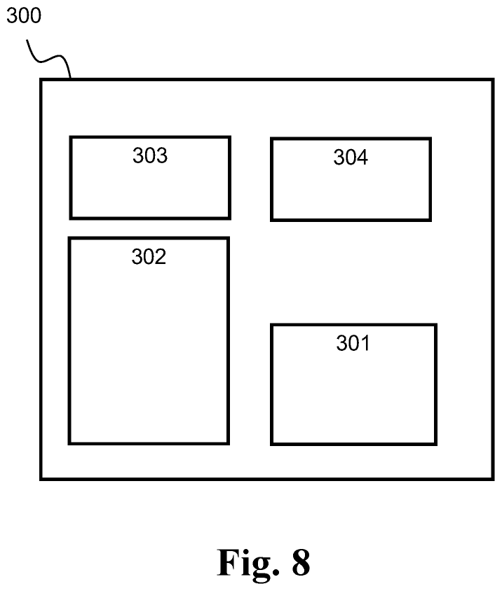

FIG. 5 shows a flow diagram of an example method 100, performed in a network node 400 according to the disclosure. The method 100 may be performed for handling energy conditions of an energy harvesting WD such as the WD 300 of FIG. 1, FIG. 4, FIG. 6, FIG. 8, and. The method 100 may be performed by a network node disclosed herein, such as network node 800 of FIG. 4 and FIG. 7, such as network node 400 or CN node 600 of FIG. 1. In one or more example methods, the method 100 is performed during normal operation, such as when the WD is in connected and/or active mode when harvesting is activated.

In one or more example methods, the method 100 comprises receiving S101, from the energy harvesting WD, an energy harvesting capability report indicative of one or more of a type of a harvesting resource, an energy harvesting capacity of a harvesting resource, and an energy storage capacity available to the WD. In one or more example methods, the energy harvesting capability report may be received during registration of the WD to the network, such as to the network node. In one or more example methods, the energy harvesting capability report may be received when configuring an energy harvesting functionality in the network, such as in the network node. Receiving S101 corresponds to transmitting S201 of the WD described in relation to FIG. 6.

In one or more example methods, the energy harvesting capability report is indicative of a type of an energy harvesting resource available to the WD. In one or more example methods, the type of the energy harvesting resource may comprise one or more of ambient energy (such as light energy, wind energy and/or vibration energy), or dedicated energy (such as wireless power transfer). Ambient energy harvesting relies on energy resources that are readily available in the environment and that can be sensed by energy harvesting devices where dedicated energy harvesting are characterized by on-purpose energy transmissions from dedicated energy resources, such as from the network node, to energy harvesting WDs, such as using wireless power transfer.

Wireless power transfer may e.g. be performed by means of electromagnetic energy, such as via RF In one or more example methods, the WD may use one or more energy harvesting techniques, such as such as energy harvesting resources, for energy harvesting, such as light energy (for example via solar or indoor light), mechanical energy (for example via vibration, wind, water), thermal energy (for example via heaters, friction, solar, water, wind), and/or electromagnetic energy (for example via inductors, coils, radio frequency). These energies can be harvested from the environment or from human activity, may be converted to electrical power and used for wireless device operation. The harvested energy can also be stored in the WD, such as e.g., stored to re-chargeable Li-ion batteries, thin-film batteries, super-capacitors, or conventional capacitors. In one or more examples, the WD may be configured with hardware enabling the WD to use a plurality of different energy resources for harvesting energy. The WD may however select one or more of the plurality of the different energy resources to be used for energy harvesting during operation of the WD.

In one or more example methods, the energy harvesting capability report is indicative of energy harvesting capacity of one or more energy harvesting resource(s) available to the WD. In one or more example methods, the energy harvesting capacity is indicative of the maximum energy harvesting performance that the WD may achieve under optimal conditions, such as under optimal environmental conditions, for each energy harvesting resource of the WD. In one or more example methods, the energy harvesting capability report may be received from the WD in an RRC message, such as in an RRC (Re)-configuration message. In one or more example methods, the energy harvesting capability report may be received from the WD via PUSCH, SDT or Early Data Transmission (EDT) or a new signaling. In other words, in one or more example methods, the RRC message may be received via PUSCH, SDT or EDT.

In one or more example methods, the energy harvesting capability report is indicative of an energy storage capacity of the WD. In one or more examples, the energy storage capacity is the maximum energy level that the WD can store in its energy storage. The energy harvesting capability report may in one or more example methods, comprise an indication of the type of energy storage available to the WD, such as whether the energy storage is a re-chargeable Li-ion battery, a thin-film battery, a super-capacitor, and/or a conventional capacitor, and the respective energy storage capacity of each type of energy storage. The energy storage capacity may be defined by the electrical capacitance in Farad (F) and the voltage (V) of the energy storage. The capacity of the energy storage may also be defined in milliampere hour (mAh) which may be calculated from the capacitance and the voltage of the energy storage. In one or more examples, the type of energy resource may be represented in some parameter values, for example, “00” represents light/solar, “01” represents vibration, and so on. In one or more examples, the energy harvesting capacity can be represented as the maximum amount of energy provision from each energy harvesting resource. Maximum can herein be interpreted as in the best condition. This can be represented in some parameter values, for example: “00” represents the lowest value, such as 1-50 milliwatts (mW)/cm², “01” represents 51-100 mW/cm², and so on. In one or more examples, the parameter value may represent a value relative to the maximum amount of energy, for instance the parameter represents a value in percentage.

In one or more example methods, the network node and the WD may negotiate a one or more thresholds based on the energy harvesting capability report received from the WD.

The network node may in one or more example methods configure, such as pre-configure, the WD with a set of parameters and thresholds for each of the energy harvesting resources indicated in the energy harvesting capability report. The parameters may comprise one or more of time-gaps for UL scheduling, time-gaps for DL scheduling, channel monitoring periodicity, PDCCH skipping, and DRX configuration for IDLE and/or

CONNECTED modes. The parameter may comprise the time-gap between PDCCH and PUSCH reception. The configuration may indicate at which energy level and/or threshold an adjustment of the transmission configuration is to be performed, for different scenarios and for different energy harvesting techniques and/or resources of the WD. The set of thresholds may comprise on or more of an energy storage level threshold, and one or more energy harvesting efficiency thresholds.

The method 100 comprises receiving S103, from the WD, a message indicative of a present energy storage level and a present energy harvesting efficiency of the WD. The present energy storage level may be indicative of a remaining energy storage level of the WD. The present energy storage level, may in one or more example methods, be indicated as a percentage of an energy storage capacity of the WD, wherein the energy storage capacity is the maximum energy level that the WD is able to store in its energy storage. The energy storage level may indicate the remaining energy storage level with no charging and/or energy harvesting ongoing. In one or more example methods, the present energy storage level may be indicated as a remaining operating time of the WD. The message indicative of the present energy storage level and the present energy harvesting efficiency may be ongoing, such as continuously received at a certain time interval or continuously received upon a triggering event occurring, during the normal operation when harvesting is activated for the WD.

The present energy harvesting efficiency may indicate to what extent energy harvesting is possible in relation to the WD's energy harvesting capabilities, such as in relation to the energy harvesting resources being available to the WD. In other words, the energy harvesting efficiency may be indicative of how fast, such as at what rate, the WD is able to harvest energy. The harvested energy may be used to recharge the energy storage of the WD.

In one or more example methods, the message indicative of a present energy storage level and the present energy harvesting efficiency of the WD may be indicative of updated capabilities, such as updated energy harvesting resources available to the WD and/or updated energy harvesting efficiencies for the energy harvesting resources available to the WD. The WD may in one or more example methods indicate a change of an energy storage status or energy harvesting resources, by transmitting a smaller message comprising the changes instead of transmitting a full set of parameters.

In one or more example methods, the message indicative of a present energy storage level and the present energy harvesting efficiency of the WD may be indicative of preferred parameters for adjusting of UL and/or down-link communication, such as a preferred uplink/downlink time-gap value or a preferred DRX cycle on and off length.

In one or more example methods, the present energy harvesting efficiency is indicated as an absolute energy harvesting efficiency value presently available to the WD. The absolute energy harvesting efficiency value may in one or more example methods be indicated as a harvesting power presently available to the WD. The harvesting power may be indicated as energy/time, such as Joule/second (J/s) or Watt (W).

In one or more example methods, the present energy harvesting efficiency is indicated based on the energy harvesting capability report of the WD. The present energy harvesting efficiency may in one or more example methods be indicated in a table comprising the type of energy harvesting resources available to the WD and/or the current energy harvesting efficiency for each type of the available energy harvesting resources.

In one or more example methods, the present energy harvesting efficiency is indicated as a relative harvesting efficiency in relation to the energy harvesting capacity of the one or more energy harvesting resource(s) available to the WD. The present energy harvesting efficiency may in one or more example methods be indicated as a percentage associated with the energy harvesting capacity of the one or more energy harvesting resource(s) available to the WD. In other words, the energy harvesting efficiency may be indicated as a percentage of the maximum energy harvesting capacity for each of the energy harvesting resources available to the WD or as a percentage of a maximum aggregated energy harvesting capacity for all of the energy harvesting resources available to the WD.

An energy harvesting efficiency of 100% may for example mean that energy harvesting is possible using 100% of the energy resource's capacity. For example, if the WD has indicated in the capability report that the type of energy harvesting resource is a solar panel with an energy harvesting capacity of 50 mW/cm², a harvesting efficiency of 100% means that the present harvesting efficiency of the solar panel is equivalent to the full capacity of 50 mW/cm². Correspondingly, a 50% energy harvesting efficiency means that only half of the energy harvesting capacity is available, such as equivalent to 25 mW/cm². The harvesting efficiency may for example be indicated in percentage steps, such as [100%, 75%, 50%, 25% . . . 0%], of the energy harvesting capacity. The granularity of the percentage steps may be fixed, such as in 1%, 10%, or 25% steps or anything in-between. In one or more example methods, the granularity of the percentage steps may be variable, such that the steps become larger at higher harvesting efficiencies, such as steps of 25% in the range of 25-100% charging efficiency and smaller steps at lower harvesting efficiencies, such as steps of 10% or 5% in the range of 0-25% harvesting efficiency. This allows the network node to adjust the communication in further detail when the harvesting efficiency is low, to ensure that the WD has sufficient time for harvesting energy.

In one or more example methods, the present energy harvesting efficiency is indicated as energy storage level per time unit. The message may for example indicate that the WD has a harvesting efficiency of X mW of power in Y min. In other words, the WD may harvest X mW of power in Y min. In one or more example methods, the message may indicate that the WD may harvest a sufficient energy level in a certain time period.

In one or more example methods, the energy storage level per time unit is indicated as a percentage of the energy storage capacity, such as of the maximum energy storage capacity, per time unit

In one or more example methods, such as when the WD is in RRC Connected mode, the message indicative of the present energy storage level and the present energy harvesting efficiency of the WD may be received in an RRC message, such as in a UE Assistance Information (UAI) message.

In one or more example methods, such as when the WD is in RRC Idle mode, the message indicative of the present energy storage level and the present energy harvesting efficiency of the WD may be received as part of a Random Access Channel (RACH) procedure such as comprised in a random access message, such as in a msg 1 and/or in a RACH preamble, received by the network node.

In one or more example methods, such as when the WD is in RRC Idle mode, the message indicative of the present energy storage level and the present energy harvesting efficiency of the WD may be received in a Small Data Transmission, such as comprised in an RRC message inside a msg 3, received by the network node.

In one or more example methods, the message indicative of the present energy storage level and the present energy harvesting efficiency of the WD is comprised in or attached to, such as piggybacked to, an uplink transmission received by the network node.

Piggybacked to means that the indication is carried by another uplink transmission (for example a data transmission, or other signaling). In other words, the message may not be a dedicated uplink transmission carrying the indication of the present energy storage level and the present energy harvesting efficiency of the WD.

Receiving S103 corresponds to transmitting S203 of the WD described in relation to FIG. 6.

The method 100 comprises communicating S107, with the WD, based on the received message indicative of the present energy storage level and the present energy harvesting efficiency of the WD. Communicating S107 corresponds to communicating S207 of the WD described in relation to FIG. 6.

Communicating S107 based on the received message may be ongoing, such as may be continuously performed during the normal operation when energy harvesting is activated for the WD.

In one or more example methods, communicating S107 comprises adjusting S107A, based on the message indicative of the energy storage level and the present energy harvesting efficiency, a configuration applied when communicating with the WD. The network node may adapt the configuration applied when communicating with the WD, for example based on the parameters comprised and/or indicated in the message received from the WD, to adapt the configuration to the new “requirements” or energy storage and harvesting efficiency of the WD.

In one or more example methods, the configuration comprises time-gaps in the scheduling of communication with the WD. Adjusting S107A the configuration may in one or more example methods comprise adjusting S107AC the time-gaps in the scheduling of communication based on the message indicative of the energy storage and the energy harvesting efficiency of the WD. The time-gaps in the scheduling of the communication may in one or more example methods be time-gaps for energy harvesting, in which time-gaps the WD is not scheduled to communicate and can perform energy harvesting. The time-gaps may be time-gaps between one or more PUSCH occasions, between one or more PDSCH occasions, between PUSCH occasions and PDCCH occasions, between PUCCH occasions and PDCCH occasions, between PDSCH occasions and PDCCH occasions, between PDCCH occasions and PUCCH occasions, and/or between PDCCH occasions and PDSCH occasions.

In one or more example methods, the configuration comprises one or more of a maximum data-rate, a maximum number of antennas, and a maximum operating bandwidth, for communication with the WD. Adjusting S107A the configuration may in one or more example methods comprise adjusting S107AD the data-rate, the maximum number of antennas, and/or the maximum operating bandwidth, for communication with the WD based on the message indicative of the energy storage and the energy harvesting efficiency of the WD. The maximum data-rate may be associated with a maximum modulation scheme, and/or a maximum number of transmission layers. For example, the adjusted configuration for communicating with the WD may comprise a lower order modulation scheme. Thereby, the WD can be operated with a low-complexity mode to reduce a power consumption of the WD. In the low-complexity mode the WD may operate only a subset of its transceiver, such as using only a subset of its antennas. In other words, the WD does not operate the transceiver with full function and/or capacity.

In one or more example methods, the configuration comprises a Discontinuous Reception, DRX, scheme for the WD. Adjusting S107A the configuration may in one or more example methods comprise adjusting S107AE the DRX-scheme based on the message indicative of the energy storage and the energy harvesting efficiency of the WD. The adjusted DRX scheme may be a specific DRX-scheme configured for an energy harvesting device configuration based on the energy storage level and energy harvesting efficiency received from the WD.

In one or more example methods, adjusting S107A comprises applying S107AA the adjusted configuration in the network node.

In one or more example methods, adjusting S107A comprises transmitting S107AB the adjusted configuration to the energy harvesting WD. The adjusted configuration may be transmitted using higher layer protocol (e.g., RRC signaling), such as in an RRC re-configuration message, or may be transmitted using lower layer protocol, such as physical layer (PHY) signaling. In one or more example methods, transmitting the adjusted configuration may be performed prior to communicating S107 with the WD, such as in an independent step prior to communicating with the WD. Transmitting S107AB corresponds to receiving S205 of the WD described in relation to FIG. 6.

In one or more example methods, the adjusting S107A is performed upon the indicated present energy storage level being equal to or lower than a predetermined energy storage level threshold. The energy storage level threshold may for example be indicative of an energy level at which the WD may no longer be able to communicate with the network node. The configuration may thus be adjusted to allow the WD to harvest enough energy to proceed with the communication. The energy storage level threshold may be configured during an RRC configuration procedure between the WD and the network node. The energy storage level threshold may be configured based on the energy harvesting capability report from the WD.

In one or more example methods, the adjusting S107A is performed upon the indicated present energy harvesting efficiency being equal to or below a predetermined first energy harvesting efficiency threshold. In one or more example methods, the predetermined first energy harvesting efficiency threshold may be indicative of a minimum energy harvesting efficiency. Upon the energy harvesting efficiency reaching the first energy harvesting efficiency threshold, the configuration may be adjusted to allow the WD more time to harvest energy using its available energy harvesting efficiency. The first energy harvesting efficiency threshold may be configured during an RRC configuration procedure between the WD and the network node. The first energy harvesting efficiency threshold may be configured based on the energy harvesting capability report from the WD.

In one or more example methods, the adjusting S107A is performed upon the indicated present energy harvesting efficiency being equal to or above a predetermined second energy harvesting efficiency threshold. The second energy harvesting efficiency threshold may be configured during an RRC configuration procedure between the WD and the network node. The second energy harvesting efficiency threshold may be configured based on the energy harvesting capability report from the WD. When the indicated present energy harvesting efficiency being equal to or above a predetermined second energy harvesting efficiency threshold, the configuration may be adjusted by reducing the time-gaps. By reducing the time-gaps a delay in the communication between the WD and the network node may be reduced.

FIG. 6 shows a flow diagram of an example method 200, performed in an energy harvesting WD 300 according to the disclosure, for handling energy conditions of the WD. The method 200 may be performed by an energy harvesting WD disclosed herein, such as energy harvesting WD 300 of FIG. 1, and FIG. 4.

In one or more example methods, the method 200 comprises transmitting S201, to the network node, an energy harvesting capability report indicative of a type and/or a capacity of a harvesting resource and energy storage capacity available to the WD. In one or more example methods, the energy harvesting capability report is indicative of a type of an energy harvesting resource available to the WD. In one or more example methods, the energy harvesting capability report is indicative of energy harvesting capacity of one or more energy harvesting resource(s) available to the WD. In one or more example methods, the energy harvesting capability report is indicative of an energy storage capacity of the WD. Transmitting S201 corresponds to receiving S101 of the network node described in relation to FIG. 5.

The method 200 comprises transmitting S203, to the network node, a message indicative of a present energy storage level and a present energy harvesting efficiency of the WD. In one or more example methods, the present energy harvesting efficiency is indicated as an absolute energy harvesting efficiency value presently available to the WD. The absolute energy harvesting efficiency value is, in one or more example methods, indicated as a harvesting power presently available to the WD. Transmitting S203 corresponds to receiving S103 of the network node described in relation to FIG. 5.

In one or more example methods, the present energy harvesting efficiency is indicated based on the energy harvesting capability report of the WD. The present energy harvesting efficiency may in one or more example methods be indicated in a table comprising the type of energy harvesting resources available to the WD and/or the current energy harvesting efficiency for each type of the available energy harvesting resources.

In one or more example methods, the present energy harvesting efficiency is indicated as a relative harvesting efficiency in relation to the capacity of the one or more energy harvesting resource(s) available to the WD.

In one or more example methods, the present energy harvesting efficiency is indicated as a percentage associated with the capacity of the one or more energy harvesting resource(s) available to the WD. In other words, the energy harvesting efficiency may be indicated as a percentage of the maximum energy harvesting capacity for each of the energy harvesting resources available to the WD or as a percentage of a maximum aggregated energy harvesting capacity for all of the energy harvesting resources available to the WD.

In one or more example methods, the present energy harvesting efficiency is indicated as energy storage level per time unit. In one or more example methods, the message may indicate that a sufficient energy level may be harvested in a certain time period, such as for example that a certain percentage of the energy storage capacity can be harvested in a certain time period. In one or more example methods, the message may indicate that the WD has a harvesting efficiency of X mW of power in Y min. In other words, the WD may harvest X mW of power in Y min.

In one or more example methods, the energy storage level per time unit is indicated as a percentage of the energy storage capacity, such as of the maximum energy storage capacity, per time unit.

In one or more example methods, the message indicative of the present energy storage level and the present energy harvesting efficiency of the WD is comprised in one or more of a UE Assistance Information message, a random access message or a Small Data Transmission transmitted by the WD. In one or more example methods, such as when the WD is in RRC Connected mode, the message indicative of the present energy storage level and the present energy harvesting efficiency of the WD may be transmitted in an RRC message, such as in a UE Assistance Information message. In one or more example methods, such as when the WD is in RRC Idle mode, the message indicative of the present energy storage level and the present energy harvesting efficiency of the WD may be received as part of a Random Access Channel (RACH) procedure such as comprised in a random access message, such as in a msg 1 and/or in a RACH preamble, transmitted by the WD. In one or more example methods, such as when the WD is in RRC Idle mode, the message indicative of the present energy storage level and the present energy harvesting efficiency of the WD may be transmitted in a Small Data Transmission, such as comprised in an RRC message inside a msg 3, transmitted by the WD.

In one or more example methods, the message indicative of the present energy storage level and the present energy harvesting efficiency of the WD is comprised in or attached to, such as piggybacked to, an up-link transmission transmitted by the WD. Piggybacked to means that the indication is carried by another uplink transmission (for example a data transmission, or other signaling). In other words, the message may not be a dedicated uplink transmission carrying the indication of the present energy storage level and the present energy harvesting efficiency of the WD.

In one or more example methods, the transmitting S203 is performed upon the present energy storage level of the WD being equal to or lower than a predetermined energy storage level threshold.

In one or more example methods, the transmitting S203 is performed upon the present energy harvesting efficiency being equal to or below a predetermined first energy harvesting efficiency threshold.

In one or more example methods, the transmitting S203 is performed upon the present energy harvesting efficiency being equal to or above a predetermined second energy harvesting efficiency threshold

In one or more example methods, the transmitting S203 is performed periodically, such as at regularly occurring intervals.

In one or more example methods, the method 200 comprises receiving S205, from the network node, an adjusted configuration to be applied when communicating with the network node. In one or more example methods, the adjusted configuration comprises time-gaps in the scheduling of communication with the WD. The time-gaps in the scheduling of the communication may in one or more example methods be time-gaps for energy harvesting, in which time-gaps the WD is not scheduled to communicate and can perform energy harvesting. The time-gaps may be time-gaps between one or more PUSCH occasions, between one or more Physical Downlink Shared Channel (PDSCH) occasions, between PUSCH occasions and PDCCH occasions, between Physical Uplink Control Channel (PUCCH) occasions and PDCCH occasions, between PDSCH occasions and PDCCH occasions, between PDCCH occasions and PUCCH occasions, and/or between PDCCH occasions and PDSCH occasions. In one or more example methods, the adjusted configuration comprises a maximum data-rate for communication with the WD. The maximum data-rate may be associated with a maximum modulation scheme, and/or a maximum number of transmission layers. For example, the adjusted configuration for communicating with the WD may comprise a lower order modulation scheme. Thereby, the WD can be operated with a low-complexity mode to reduce a power consumption of the WD. In the low-complexity mode the WD may operate only a subset of its transceiver, such as using only a subset of its antennas. In other words, the WD does not operate the transceiver with full function and/or capacity. In one or more example methods, the adjusted configuration comprises a Discontinuous Reception, DRX, scheme for the WD. Receiving S205 corresponds to transmitting S107AB of the network node described in relation to FIG. 5.

The method 200 comprises communicating S207, with the network node, based on the transmitted message indicative of the present energy storage level and the present energy harvesting efficiency of the WD. Communicating S207 corresponds to communicating S107 of the network node described in relation to FIG. 5.

In one or more example methods, communicating S207 comprises applying S207A the adjusted configuration when communicating with the network node. In one or more example methods, the adjusted configuration based on the message indicative of the energy storage level and the energy harvesting efficiency.

In one or more example methods, applying S207A the adjusted configuration comprises applying S207AA the adjusted time-gaps to the communication with the network node. The method may comprise performing energy harvesting in the adjusted time-gaps.

In one or more example methods, applying S207A the adjusted configuration comprises applying S207AB the adjusted data-rate to communications with the network node.

In one or more example methods, the applying S207A the adjusted configuration comprises applying S207AC the adjusted DRX-scheme to communications with the network node.

FIG. 7 shows a block diagram of an example network node 800 according to the disclosure. The network node 800 comprises memory circuitry 401, processor circuitry 402, and a wireless interface 403. The network node 800 may be configured to perform any of the methods disclosed in FIG. 5. In other words, the network node 800 may be configured handling energy conditions of an energy harvesting WD. In one or more examples, the network node 800 is a radio network node 400. In one or more example methods, the network node 800 is a core network node 600, the core network node 600 communicating with the WD 300 via the radio network node 400.

The network node 800 is configured to receive (such as using the wireless interface 403), from the WD, a message indicative of a present energy storage level and a present energy harvesting efficiency of the WD.

The network node 800 is configured to communicate (such as using the wireless interface 403), with the WD, based on the received message.

The wireless interface 403 is configured for wireless communications via a wireless communication system, such as a 3GPP system, such as a 3GPP system supporting one or more of: New Radio, NR, Narrow-band loT, NB-IoT, Long Term Evolution (LTE), and LTE-enhanced Machine Type Communication, LTE-M, millimeter-wave communications, such as millimeter-wave communications in licensed bands, such as device-to-device millimeter-wave communications in licensed bands.

Processor circuitry 402 is optionally configured to perform any of the operations disclosed in FIG. 5 (such as any one or more of S101, S107A, S107AA, S107AB, S107AC, S107AD, S107AE). The operations of the network node 800 may be embodied in the form of executable logic routines (for example, lines of code, software programs, etc.) that are stored on a non-transitory computer readable medium (for example, memory circuitry 401) and are executed by processor circuitry 402).

Furthermore, the operations of the network node 800 may be considered a method that the network node 800 is configured to carry out. Also, while the described functions and operations may be implemented in software, such functionality may also be carried out via dedicated hardware or firmware, or some combination of hardware, firmware and/or software.

Memory circuitry 401 may be one or more of a buffer, a flash memory, a hard drive, a removable media, a volatile memory, a non-volatile memory, a random access memory (RAM), or other suitable device. In a typical arrangement, memory circuitry 401 may include a non-volatile memory for long term data storage and a volatile memory that functions as system memory for processor circuitry 402. Memory circuitry 401 may exchange data with processor circuitry 402 over a data bus. Control lines and an address bus between memory circuitry 401 and processor circuitry 402 also may be present (not shown in FIG. 7). Memory circuitry 401 is considered a non-transitory computer readable medium.

Memory circuitry 401 may be configured to store information such as a present energy harvesting efficiency of the WD, a present energy level of the WD, an energy harvesting capability report of the WD and/or a configuration for communicating with the WD in a part of the memory.

FIG. 8 shows a block diagram of an example WD 300, such as an energy harvesting WD, according to the disclosure. The WD 300 comprises memory circuitry 301, processor circuitry 302, and a wireless interface 303 and energy harvesting circuitry 304. The WD 300 may be configured to perform any of the methods disclosed in FIG. 6. In other words, the WD 300 may be configured for handling energy conditions of the WD.

The WD 300 is configured to transmit (such as using the wireless interface 303), to the network node, a message indicative of a present energy storage level and a present energy harvesting efficiency of the WD.

The WD 300 is configured to communicate (such as via the wireless interface 303), with the network node, based on the transmitted message indicative of the present energy storage level and the present energy harvesting efficiency of the WD.

The wireless interface 303 is configured for wireless communications via a wireless communication system, such as a 3GPP system, such as a 3GPP system supporting one or more of: New Radio, NR, Narrow-band loT, NB-IoT, Long Term Evolution (LTE), and LTE-enhanced Machine Type Communication, LTE-M, millimeter-wave communications, such as millimeter-wave communications in licensed bands, such as device-to-device millimeter-wave communications in licensed bands.

The energy harvesting circuit 304 may be configured to harvest energy from an energy resource. The energy resource may be an ambient energy (such as light energy, wind energy and/or vibration energy), or a dedicated energy resource (such as wireless power transfer). Ambient energy harvesting relies on energy resources that are readily available in the environment and that can be sensed by energy harvesting devices where dedicated energy harvesting are characterized by on-purpose energy transmissions from dedicated energy resources to energy devices. The energy harvesting circuit 304 may in one or more example WDs comprise a limited energy storage (such as a battery, super capacitor, etc).

The WD 300 is optionally configured to perform any of the operations disclosed in FIG. 6 (such as any one or more of S201, S205, S207A, S207AA, S207AB, S207AC). The operations of the WD 300 may be embodied in the form of executable logic routines (for example, lines of code, software programs, etc.) that are stored on a non-transitory computer readable medium (for example, memory circuitry 301) and are executed by processor circuitry 302).

Furthermore, the operations of the WD 300 may be considered a method that the WD 300 is configured to carry out. Also, while the described functions and operations may be implemented in software, such functionality may also be carried out via dedicated hardware or firmware, or some combination of hardware, firmware and/or software.

Memory circuitry 301 may be one or more of a buffer, a flash memory, a hard drive, a removable media, a volatile memory, a non-volatile memory, a random access memory (RAM), or other suitable device. In a typical arrangement, memory circuitry 301 may include a non-volatile memory for long term data storage and a volatile memory that functions as system memory for processor circuitry 302. Memory circuitry 301 may exchange data with processor circuitry 302 over a data bus. Control lines and an address bus between memory circuitry 301 and processor circuitry 302 also may be present (not shown in FIG. 8. Memory circuitry 301 is considered a non-transitory computer readable medium.

Memory circuitry 301 may be configured to store information such as a configuration for communicating with the network node in a part of the memory.

Examples of methods and products (network node and wireless device) according to the disclosure are set out in the following items:

Item 1. A method, performed in a network node, for handling energy conditions of an energy harvesting wireless device, WD, the method comprising:
receiving (S103), from the WD, a message indicative of a present energy storage level and a present energy harvesting efficiency of the WD, and
communicating (S107), with the WD, based on the received message.

Item 2. The method according to Item 1, wherein the present energy harvesting efficiency is indicated as an absolute energy harvesting efficiency value presently available to the WD.

Item 3. The method according to Item 2, wherein the absolute energy harvesting efficiency value is indicated as a harvesting power presently available to the WD.

Item 4. The method according to any one of the Items 1-3, wherein the present energy harvesting efficiency is indicated based on an energy harvesting capability report of the WD, wherein the energy harvesting capability report is indicative of one or more of:
a type of an energy harvesting resource available to the WD,
energy harvesting capacity of one or more energy harvesting resource(s) available to the WD and
an energy storage capacity of the WD.

Item 5. The method according to Item 4, wherein the present energy harvesting efficiency is indicated as a relative harvesting efficiency in relation to the energy harvesting capacity of the one or more energy harvesting resource(s) available to the WD.

Item 6. The method according to any one of the Items 4-5, wherein the present energy harvesting efficiency is indicated as a percentage associated with the energy harvesting capacity of the one or more energy harvesting resource(s) available to the WD.

Item 7. The method according to any one of the Items 4-6, wherein the present energy harvesting efficiency is indicated as energy storage level per time unit.

Item 8. The method according to Item 7, wherein the energy storage level per time unit is indicated as a percentage of the energy storage capacity per time unit.

Item 9. The method according to any one of the previous Items, wherein the message indicative of the present energy storage level and the present energy harvesting efficiency of the WD is received in one or more of: a UE Assistance Information message, a random access message, and a Small Data Transmission received by the network node.

Item 10. The method according to any one of the previous Items, wherein the message indicative of the present energy storage level and the present energy harvesting efficiency of the WD is comprised in or attached to an uplink transmission received by the network node.

Item 11. The method according to any one of the previous Items, wherein communicating (S107) comprises adjusting (S107A), based on the message indicative of the energy storage level and the present energy harvesting efficiency, a configuration applied when communicating with the WD.

Item 12. The method according to Item 11, wherein adjusting (S107A) comprises applying (S107AA) the adjusted configuration in the network node.

Item 13. The method according to any one of the Items 11-12, wherein adjusting (S107A) comprises transmitting (S107AB) the adjusted configuration to the WD.

Item 14. The method according to any one of the Items 11-13, wherein the configuration comprises time-gaps in the scheduling of communication with the WD, and wherein adjusting (S107A) the configuration comprises adjusting (S107AC) the time-gaps in the scheduling of communication based on the message indicative of the energy storage and the energy harvesting efficiency of the WD.

Item 15. The method according to any one of the Items 11-14, wherein the configuration comprises a maximum data-rate for communication with the WD, and wherein adjusting (S107A) the configuration comprises adjusting (S107AD) the data-rate for communication with the WD based on the message indicative of the energy storage and the energy harvesting efficiency of the WD.

Item 16. The method according to any one of the Items 11-15, wherein the configuration comprises a Discontinuous Reception, DRX, scheme for the WD, and wherein adjusting (S107A) the configuration comprises adjusting (S107AE) the DRX-scheme based on the message indicative of the energy storage and the energy harvesting efficiency of the WD.

Item 17. The method according to any of the Items 11-16, wherein adjusting (S107A) is performed upon the indicated present energy storage level being equal to or lower than a predetermined energy storage level threshold.

Item 18. The method according to any of the Items 11-17, wherein adjusting (S107A) is performed upon the indicated present energy harvesting efficiency being equal to or below a predetermined first energy harvesting efficiency threshold.

Item 19. The method according to any of the Items 11-18, wherein adjusting (S107A) is performed upon the indicated present energy harvesting efficiency being equal to or above a predetermined second energy harvesting efficiency threshold.

Item 20. The method according to any one of the previous Items, wherein the method comprises receiving (S101), from the energy harvesting WD, an energy harvesting capability report indicative of one or more of a type of a harvesting resource, an energy harvesting capacity of a harvesting resource and an energy storage capacity available to the WD.

Item 21. A method, performed in an energy harvesting wireless device, WD, for handling energy conditions of the WD, the method comprising:
transmitting (S203), to the network node, a message indicative of a present energy storage level and a present energy harvesting efficiency of the WD, and
communicating (S207), with the network node, based on the transmitted message indicative of the present energy storage level and the present energy harvesting efficiency of the WD.

Item 22. The method according to Item 21, wherein the present energy harvesting efficiency is indicated as an absolute energy harvesting efficiency value presently available to the WD.

Item 23. The method according to Item 22, wherein the absolute energy harvesting efficiency value is indicated as a harvesting power presently available to the WD.

Item 24. The method according to any one of the Items 21-23, wherein the present energy harvesting efficiency is indicated based on an energy harvesting capability report of the WD, wherein the energy harvesting capability report is indicative of one or more of:
a type of an energy harvesting resource available to the WD,
energy harvesting capacity of one or more energy harvesting resource(s) available to the WD and
an energy storage capacity of the WD.

Item 25. The method according to Item 24, wherein the present energy harvesting efficiency is indicated as a relative harvesting efficiency in relation to the energy harvesting capacity of the one or more energy harvesting resource(s) available to the WD.

Item 26. The method according to any one of the Items 24-25, wherein the present energy harvesting efficiency is indicated as a percentage associated with the energy harvesting capacity of the one or more energy harvesting resource(s) available to the WD.

Item 27. The method according to any one of the Items 24-26, wherein the present energy harvesting efficiency is indicated as energy storage level per time unit.

Item 28. The method according to Item 27, wherein the energy storage level per time unit is indicated as a percentage of the energy storage capacity per time unit.

Item 29. The method according to any one of the Items 21-28, wherein the message indicative of the present energy storage level and the present energy harvesting efficiency of the WD is comprised in one or more of: an UE Assistance Information message, a random access message, and a Small Data Transmission transmitted by the WD.

Item 30. The method according to any one of the Items 21-29, wherein the message indicative of the present energy storage level and the present energy harvesting efficiency of the WD is comprised in an up-link transmission transmitted by the WD.

Item 31. The method according to any one of the Items 21-30, wherein communicating (S207) comprises applying (S207A) an adjusted configuration when communicating with the network node, wherein the configuration is adjusted based on the message indicative of the energy storage level and the energy harvesting efficiency.

Item 32. The method according to Item 31, wherein the method comprises:
receiving (S205), from the network node, the adjusted configuration to be applied when communicating with the network node.

Item 33. The method according to any one of the Items 31-32, wherein the adjusted configuration comprises time-gaps in the scheduling of communication with the network node, and wherein applying the adjusted configuration comprises applying the adjusted time-gaps to the communication with the network node.

Item 34. The method according to any one of the Items 31-33, wherein the adjusted configuration comprises a maximum data-rate for communication with the network node, and wherein applying the adjusted configuration comprises applying the adjusted data-rate to communications with the network node.

Item 35. The method according to any one of the Items 31-34, wherein the adjusted configuration comprises an adjusted Discontinuous Reception, DRX, scheme for the WD, and wherein applying the adjusted configuration comprises applying the adjusted DRX-scheme to communications with the network node.

Item 36. The method according to any one of the Items 21-35, wherein the method comprises transmitting (S201), to the network node, an energy harvesting capability report indicative of a type and/or a capacity of a harvesting resource and energy storage capacity available to the WD.

Item 37. The method according to any one of the Items 21-36, wherein transmitting (S203) is performed upon the present energy storage level of the WD being equal to or lower than a predetermined energy storage level threshold.

Item 38. The method according to any one of the Items 21-36, wherein transmitting (S203) is performed upon the present energy harvesting efficiency being equal to or below a predetermined first energy harvesting efficiency threshold.

Item 39. The method according to any one of the Items 21-36, wherein transmitting (S203) is performed upon the present energy harvesting efficiency being equal to or above a predetermined second energy harvesting efficiency threshold.

Item 40. The method according to any one of the Items 21-36, wherein transmitting (S203) is performed periodically.

Item 41. A network node comprising memory circuitry, processor circuitry, and a wireless interface, wherein the network node is configured to perform any of the methods according to any of the Items 1-20.

Item 42. A wireless device comprising memory circuitry, processor circuitry, and a wireless interface, wherein the wireless device is configured to perform any of the methods according to any of the Items 21-40.

The use of the terms “first”, “second”, “third” and “fourth”, “primary”, “secondary”, “tertiary” etc. does not imply any particular order, but are included to identify individual elements. Moreover, the use of the terms “first”, “second”, “third” and “fourth”, “primary”, “secondary”, “tertiary” etc. does not denote any order or importance, but rather the terms “first”, “second”, “third” and “fourth”, “primary”, “secondary”, “tertiary” etc. are used to distinguish one element from another. Note that the words “first”, “second”, “third” and “fourth”, “primary”, “secondary”, “tertiary” etc. are used here and elsewhere for labelling purposes only and are not intended to denote any specific spatial or temporal ordering. Furthermore, the labelling of a first element does not imply the presence of a second element and vice versa.

It may be appreciated that FIGS. 1 to 8 comprise some circuitries or operations which are illustrated with a solid line and some circuitries, components, features, or operations which are illustrated with a dashed line. Circuitries or operations which are comprised in a solid line are circuitries, components, features or operations which are comprised in the broadest example. Circuitries, components, features, or operations which are comprised in a dashed line are examples which may be comprised in, or a part of, or are further circuitries, components, features, or operations which may be taken in addition to circuitries, components, features, or operations of the solid line examples. It should be appreciated that these operations need not be performed in order presented. Furthermore, it should be appreciated that not all of the operations need to be performed. The example operations may be performed in any order and in any combination. It should be appreciated that these operations need not be performed in order presented. Circuitries, components, features, or operations which are comprised in a dashed line may be considered optional.

Other operations that are not described herein can be incorporated in the example operations. For example, one or more additional operations can be performed before, after, simultaneously, or between any of the described operations.

Certain features discussed above as separate implementations can also be implemented in combination as a single implementation. Conversely, features described as a single implementation can also be implemented in multiple implementations separately or in any suitable sub-combination. Moreover, although features may be described above as acting in certain combinations, one or more features from a claimed combination can, in some cases, be excised from the combination, and the combination may be claimed as any sub-combination or variation of any sub-combination.

It is to be noted that the word “comprising” does not necessarily exclude the presence of other elements or steps than those listed.

It is to be noted that the words “a” or “an” preceding an element do not exclude the presence of a plurality of such elements.

It should further be noted that any reference signs do not limit the scope of the claims, that the examples may be implemented at least in part by means of both hardware and software, and that several “means”, “units” or “devices” may be represented by the same item of hardware.

The various example methods, devices, nodes and systems described herein are described in the general context of method steps or processes, which may be implemented in one aspect by a computer program product, embodied in a computer-readable medium, including computer-executable instructions, such as program code, executed by computers in networked environments. A computer-readable medium may include removable and non-removable storage devices including, but not limited to, Read Only Memory (ROM), Random Access Memory (RAM), compact discs (CDs), digital versatile discs (DVD), etc. Generally, program circuitries may include routines, programs, objects, components, data structures, etc. that perform specified tasks or implement specific abstract data types. Computer-executable instructions, associated data structures, and program circuitries represent examples of program code for executing steps of the methods disclosed herein. The particular sequence of such executable instructions or associated data structures represents examples of corresponding acts for implementing the functions described in such steps or processes.

Although features have been shown and described, it will be understood that they are not intended to limit the claimed disclosure, and it will be made obvious to those skilled in the art that various changes and modifications may be made without departing from the scope of the claimed disclosure. The specification and drawings are, accordingly, to be regarded in an illustrative rather than restrictive sense. The claimed disclosure is intended to cover all alternatives, modifications, and equivalents.

1. A method, performed in a network node, for handling energy conditions of an energy harvesting wireless device (WD), the method comprising:
receiving, from the WD, a message indicative of a present energy storage level and a present energy harvesting efficiency of the WD, and
communicating, with the WD, based on the received message.

2. The method according to claim 1, wherein the present energy harvesting efficiency is indicated as an absolute energy harvesting efficiency value presently available to the WD.

3. The method according to claim 2, wherein the absolute energy harvesting efficiency value is indicated as a harvesting power presently available to the WD.

4. The method according to claim 1, wherein the present energy harvesting efficiency is indicated based on an energy harvesting capability report of the WD, wherein the energy harvesting capability report is indicative of one or more of:
a type of an energy harvesting resource available to the WD,
energy harvesting capacity of one or more energy harvesting resource(s) available to the WD and
energy storage capacity of the WD.

5. The method according to claim 4, wherein the present energy harvesting efficiency is indicated as a relative harvesting efficiency in relation to the energy harvesting capacity of the one or more energy harvesting resource(s) available to the WD.

6. The method according to claim 4, wherein the present energy harvesting efficiency is indicated as a percentage associated with the energy harvesting capacity of the one or more energy harvesting resource(s) available to the WD.

7. The method according to claim 4, wherein the present energy harvesting efficiency is indicated as energy storage level per time unit.

8. The method according to claim 7, wherein the energy storage level per time unit is indicated as a percentage of the energy storage capacity per time unit.

9. The method according to claim 1, wherein the message indicative of the present energy storage level and the present energy harvesting efficiency of the WD is received in one or more of: a UE Assistance Information message, a random access message, and a Small Data Transmission received by the network node.

10. The method according to claim 1, wherein the message indicative of the present energy storage level and the present energy harvesting efficiency of the WD is comprised in or attached to an uplink transmission received by the network node.

11. The method according to claim 1, wherein communicating comprises adjusting, based on the message indicative of the energy storage level and the present energy harvesting efficiency, a configuration applied when communicating with the WD.

12. The method according to claim 11, wherein adjusting (S107A) comprises applying the adjusted configuration in the network node, and

13. The method according to claim 11, wherein adjusting comprises transmitting (S107AB) the adjusted configuration to the WD.

14. The method according to claim 11, wherein the configuration comprises time-gaps in the scheduling of communication with the WD, and wherein adjusting the configuration comprises adjusting the time-gaps in the scheduling of communication based on the message indicative of the energy storage and the energy harvesting efficiency of the WD.

15. The method according to claim 11, wherein the configuration comprises a maximum data-rate for communication with the WD, and wherein adjusting the configuration comprises adjusting the data-rate for communication with the WD based on the message indicative of the energy storage and the energy harvesting efficiency of the WD.

16. The method according to claim 11, wherein the configuration comprises a Discontinuous Reception (DRX) scheme for the WD, and wherein adjusting the configuration comprises adjusting the DRX-scheme based on the message indicative of the energy storage and the energy harvesting efficiency of the WD.

17. The method according to claim 11, wherein adjusting is performed upon the indicated present energy storage level being equal to or lower than a predetermined energy storage level threshold.

18. The method according to claim 11, wherein adjusting is performed upon the indicated present energy harvesting efficiency being equal to or below a predetermined first energy harvesting efficiency threshold.

19. The method according to claim 11, wherein adjusting is performed upon the indicated present energy harvesting efficiency being equal to or above a predetermined second energy harvesting efficiency threshold.

20. (canceled)

21. A method, performed in an energy harvesting wireless device (WD), for handling energy conditions of the WD, the method comprising:
transmitting, to the network node, a message indicative of a present energy storage level and a present energy harvesting efficiency of the WD, and
communicating, with the network node, based on the transmitted message indicative of the present energy storage level and the present energy harvesting efficiency of the WD.

22-42. (canceled)
